(19) United States
(12) Patent Application Publication
(10) Pub. No.: US 2010/0284872 A1
(43) Pub. Date: Nov. 11, 2010

(54) SYSTEMS AND METHODS FOR REDUCING MERCURY EMISSION

(76) Inventors: Thomas K. Gale, Vestavia Hills, AL (US); George A. Blankenship, Homewood, AL (US)

Correspondence Address: Ballard Spahr LLP, SUITE 1000, 999 PEACHTREE STREET, ATLANTA, GA, 30309-3915, US

(21) Appl. No.: 12/774,939

(22) Filed: May 6, 2010

Related U.S. Application Data
(60) Provisional application No. 61/176,564, filed on May 8, 2009.

(51) Int. Cl. B01D 53/64; B01J 19/00; C01B 7/09

(52) U.S. Cl. 423/215.5; 422/198; 423/502

(57) ABSTRACT

Described herein are methods for decreasing the amount of mercury in a flue gas that contains mercury through the use of a molecular halogen. Also described are chemical processes for carrying out the methods, and systems for carrying out the chemical processes.

### CROSS-REFERENCE TO RELATED APPLICATIONS

This application claims the benefit of priority to U.S. Provisional Application No. 61/176,564, filed on May 8, 2009, which is incorporated by reference herein in its entirety.

### BACKGROUND

When a material containing mercury is combusted, for example during an industrial combustion process, the mercury is volatilized and often emits into the atmosphere. Recent estimates suggest that United States power plants alone emit about 50 tons of mercury per year into the atmosphere. Various forms of volatilized mercury can form during combustion processes. Volatilized elemental mercury, Hg°, and oxidized mercury are typically present in flue produced from the combustion of a material containing mercury. Elemental mercury vapor has an atmospheric lifespan of several years and will travel the globe before finally oxidizing in the atmosphere and depositing onto land and in water. Oxidized mercury, by contrast, has a relatively short atmospheric lifespan and will condense along with rain into bodies of water or can deposit onto plants and subsequently wash into bodies of water.

Once the mercury finally deposits into water and settles into the biota of shallow lakes and oceans, sulfur-reducing microorganisms can convert the mercury to a very toxic and bioaccumulative organic form of mercury, methyl mercury. Methyl mercury tends to accumulate in fish and can accumulate in the humans that eat fish, potentially leading to a variety of health problems, including learning disabilities, cardiovascular diseases, autoimmune disorders, and can lead to development problems in feti. The toxicity of methyl mercury is linked to a variety of factors, including its high reactivity and long half-lives in living organisms, which can be as high as 72 days in fish and 50 days in humans. Regulations on mercury to date have focused on total vapor-phase mercury emissions from stacks (regardless of form) and the total concentration of mercury in waste-water discharge.

Various methods exist for mitigating mercury emission from the flue gas of an industrial process. Often, these methods involve first oxidizing the mercury to form HgCl₂, since elemental mercury is not easily captured from flue gas. Traditional pollution control devices, such as wet scrubbers and selective catalytic reduction (SCR) units, which are designed to capture SO₂ and destroy NO before they exit flue-gas stacks, also help to oxidize and capture mercury. Oxidized mercury, however, even if captured, can at least partially re-emit from the pollution control devices back into the flue gas and emit from the stack.

Other methods for mitigating mercury emission from flue gas involve the use of additives. One method for reducing mercury emission from a coal combustion power plant, for example, involves placing a bromide salt directly on coal prior to combustion. The bromide salt is then volatilized at high temperatures to form more potent oxidants as the coal is burned in the furnace. However, the addition of bromide salts directly onto the coal can cause boiler-tube wastage and corrosion of other component surfaces in the furnace, convection pass, and ductwork prior to reaching the location in the flue gas where it is needed to oxidize mercury. In addition, some of the desirable bromine gas may be consumed in side reactions before arriving at the point where the bromine gas is needed to oxidize mercury.

Accordingly, there exists a need for improved methods for reducing mercury emission that results from an industrial process. This need and other needs are satisfied by the present invention.

### SUMMARY

Described herein are methods for reducing mercury emission from a flue gas. Generally, the methods involve providing a relatively inert halide salt, converting the halide salt to an acid halide, and converting the acid halide to a molecular halogen that can be injected into a process stream. The mercury in the flue gas is then oxidized by the molecular halogen and removed from the process stream, thus preventing the emission of the mercury into the atmosphere. Also described are systems for carrying out the disclosed methods. Also described are improved methods for making bromine, wherein hydrobromic acid is formed from a bromide salt, and the hydrobromic acid is subsequently oxidized to bromine.

The advantages of the invention will be set forth in part in the description which follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

FIG. 1 is a graph of the % conversion of CaBr₂ to Br₂ under the process conditions described in Example 1.

FIG. 2 is an example of a disclosed system.

FIG. 3 is another example of a disclosed system.

### DETAILED DESCRIPTION

Before the present compounds, compositions, composites, articles, devices, methods, or uses are disclosed and described, it is to be understood that the aspects described below are not limited to specific compounds, compositions, composites, articles, devices, methods, or uses as such may, of course, vary. It is also to be understood that the terminology used herein is for the purpose of describing particular aspects only and is not intended to be limiting.

In this specification and in the claims that follow, reference will be made to a number of terms that shall be defined to have the following meanings:

Throughout this specification, unless the context requires otherwise, the word “comprise,” or variations such as “comprises” or “comprising,” will be understood to imply the inclusion of a stated integer or step or group of integers or steps but not the exclusion of any other integer or step or group of integers or steps.

It must be noted that, as used in the specification and the appended claims, the singular forms “a,” “an” and “the” include plural referents unless the context clearly dictates otherwise. Thus, for example, reference to “a molecular halogen” includes mixtures of two or more such molecular halogens, and the like.

“Optional” or “optionally” means that the subsequently described event or circumstance can or cannot occur, and that the description includes instances where the event or circumstance occurs and instances where it does not.

Ranges may be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Disclosed are compounds, compositions, and components that can be used for, can be used in conjunction with, can be used in preparation for, or are products of the disclosed methods and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. For example, if a number of different polymers and agents are disclosed and discussed, each and every combination and permutation of the polymer and agent are specifically contemplated unless specifically indicated to the contrary. Thus, if a class of molecules A, B, and C are disclosed as well as a class of molecules D, E, and F and an example of a combination molecule, A-D is disclosed, then even if each is not individually recited, each is individually and collectively contemplated. Thus, in this example, each of the combinations A-E, A-F, B-D, B-E, B-F, C-D, C-E, and C-F are specifically contemplated and should be considered disclosed from disclosure of A, B, and C; D, E, and F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. This concept applies to all aspects of this disclosure including, but not limited to, steps in methods of making and using the disclosed compositions. Thus, if there are a variety of additional steps that can be performed it is understood that each of these additional steps can be performed with any specific aspect or combination of aspects of the disclosed methods, and that each such combination is specifically contemplated and should be considered disclosed.

As used herein, “injecting” refers to a step wherein a molecular halogen is added to a flue gas. Typically, injecting the molecular halogen involves introducing the molecular halogen into the flue gas from a source that is separate from the flue gas itself, e.g. from an injection system.

As used herein, a “flue gas” refers to an exhaust gas that is produced from an industrial process and includes both gas that will be used in connection with the process from which it is produced or even another related process (e.g., to produce heat) and gas that is waste gas, which will exit into the atmosphere via a duct for conveying waste exhaust gases from an industrial process. The flue gas can be produced from any industrial process, wherein any form of mercury is present in the flue gas. Examples of such industrial processes include power generating processes, (e.g., combustion processes), metal smelting processes (e.g. gold smelting), chlor alkali production processes, among others.

As used herein, a “molecular halogen” is any halogen in molecular form (i. e. a species comprising more than one atom), or a product dissociated therefrom. Examples of molecular halogens include without limitation Br₂, Cl₂, F₂, and b. Products dissociated from the molecular halogen include those products that form from the molecular halogen when the molecular halogen is injected into flue gas, such as ions or other products resulting from the disassociation of the molecular halogen. For example, Br₂, at certain flue gas conditions, may become dissociated to form a Br radical, Br anion, Br cation, or a combination thereof. Such disassociation products will typically be very reactive.

A “halide salt,” as used herein, is any salt of a halide (X⁻¹, wherein X is Br, Cl, F, or I). The cationic portion of the halide salt can be any suitable cation, including without limitation cations of Group I and II elements, such as Li, Na, K, Ca, or Mg, and certain cations of transition metal elements, such as Group VIII elements, including for example, Feⁿ⁺, wherein n is 1, 2 or 3.

“Mercury,” as used herein, refers to any form of mercury, including without limitation, all oxidized forms of Hg and molecular Hg.

The present invention provides systems and methods wherein relatively inert halide salts are transformed to molecular halogens and subsequently can be directly injected at the point of need in an industrial process to oxidize mercury and subsequently reduce mercury emission from the process stream. According to the methods disclosed herein, inexpensive, easy to ship and handle halide salts can be used to form and directly inject a molecular halogen at a specific desired location needed in a process stream.

In the practice of the invention, in one aspect, an acid halide is formed in situ from a suitable halide salt passing through an injection system. A variety of halide salts can be converted into suitable acid halides, for example, by exposing the halide salt to steam to thereby form the acid halide. Halide salts in solid form are particularly useful because they are relatively inert under normal atmospheric conditions. Solid halide salts can be safely transported to and stored at the site of an industrial process location, such as a plant.

In one aspect, when bromine is desired as the molecular halogen, suitable halide salt precursors include NaBr, KBr, MgBr₂, CaBr₂, and combinations thereof. Any of these exemplary halide salts can be converted to Br₂ using water, preferably in the form of steam. Such halide salts are widely commercially available. In one aspect, CaBr₂ is used as the halide salt. CaBr₂ is available from various commercial sources including Chemtura Corporation (199 Benson Road, Middlebury, Conneticut 06749 USA), Dead Sea Bromine Company Ltd. (12 Kroitzerst, Beer Sheva 84101 Israel), Morre-Tee Industries Inc. (One Gary Road, Union, N.J. 07083 USA) and ICL Industrial Products (ICL-IP) (622 Emerson Road, St. Louis, Mo. 63141 USA).

The halide salt can be transported to the site of the industrial process and subsequently stored or used soon after delivery. Various methods exist for forming the acid halide from the halide salt. In general, any method known in the art can be used to form the acid halide. In one aspect, the halide salt is reacted with steam to provide the acid halide along with byproducts. The byproducts can either be separated from the acid halide, or used in the industrial process in another capacity or simply injected into the process stream along with the molecular halogen, provided that the byproduct does not have any deleterious effects on the process. Generally, the byproducts are harmless salts and water.

In a further aspect, hydrobromic acid (HBr) is formed from a suitable halide salt, as discussed above, by reacting the halide salt with steam, as shown in the following reaction scheme:

MₙBrₙ+H₂O→metal oxide+HBr,

wherein n is 1 or 2, and wherein M is Na, K, Mg, or Ca. One example of the above reaction is the reaction of NaBr with H₂O, according to the following reaction scheme:

2NaBr+H₂O→Na₂O+2HBr

In another specific aspect, HBr is formed from CaBr₂, according to the following reaction scheme:

CaBr₂+H₂O→CaO+2HBr.

CaBr₂ can be used to form HBr according to a number of protocols, including those methods disclosed in U.S. Pat. No. 6,630,119 to Sugie and Kimura, which is incorporated herein by this reference in its entirety for its teaching of HBr generating methods. Generally, the CaBr₂ is present in a reaction chamber in a dispersed or suspended state in air or another appropriate medium. Water (e.g., steam) can be introduced into the reactor which then reacts with the CaBr₂ to form the HBr. In the practice of this example, the reaction is typically carried out at an elevated temperature, for example by heating the reaction medium or chamber to a temperature of from about 650° C. to 1000° C., with a temperature of from about 700° C. to about 800° C. being preferred. Preferably, water is introduced into the reaction chamber as steam mixed with air, rather than as a liquid that forms a slurry with the CaBr₂.

Once the acid halide is formed, the acid halide can then be converted to the molecular halogen. A variety of methods exist for forming the molecular halogen from the acid halide. Generally, any suitable method known in the art can be used. In one aspect, the molecular halogen is formed by chemical conversion from the acid halide, for example by exposing the acid halide to oxygen. The conversion of the acid halide to the molecular halogen can be enhanced with the use of a catalyst, such as an oxidation-reduction catalyst. An example of a suitable catalyst is a metal oxide catalyst. In some aspects, the metal oxide catalyst can be present on an inert support material.

In one aspect, when the acid halide is HBr, the HBr can be converted to Br₂ in the presence of oxygen using a variety of metal oxide catalysts, including any of those catalysts disclosed in U.S. Pat. No. 3,346,340 to Louvar et al., which is incorporated herein by this reference in its entirety for its teachings of forming Br₂ from HBr. The processes disclosed in U.S. Pat. No. 3,346,340 to Louvar et al. can be used in combination with the present invention for providing Br₂. Of the various metal oxide catalysts suitable for forming Br₂ from HBr, specific examples include oxides of copper, cerium, nickel, cobalt, and manganese. In one aspect, during the practice of the invention, a catalyst bed comprising CuO can react with HBr to first form CuBr, which then can react to form Br₂

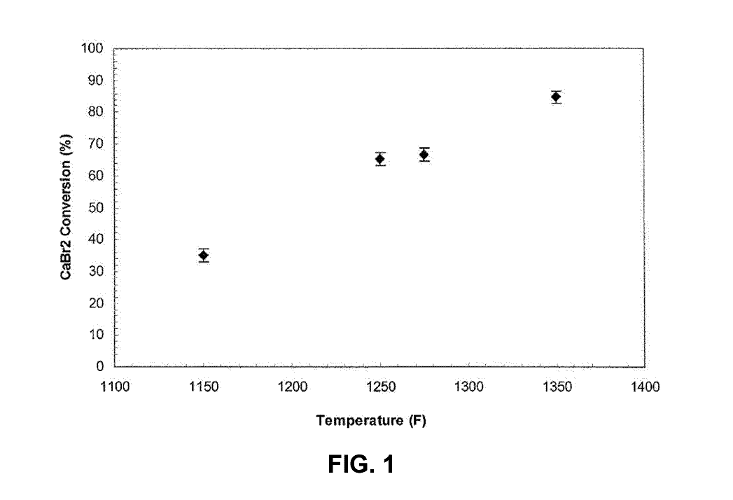

In this aspect, the formation of Br₂ from HBr is typically carried out at an elevated temperature, for example from about 250° C. to about 600° C., with temperatures from about 300° C. to about 450° C. being preferred. In an exemplary process for carrying out this reaction, the exhaust formed (i.e. exhaust comprising HBr) from the reaction of the bromide salt (e.g. CaBr₂) with steam is first cooled and subsequently directed to a catalyst bed comprising a metal oxide catalyst, such as CuO, which converts the HBr to Br₂. The Br₂ can then either be condensed and stored on site or injected directly into the industrial process stream shortly after its formation. In a specific aspect, CaBr₂ can be converted to HBr using steam, followed by the conversion of the HBr to Br, using a CuO catalyst dispersed in or on a catalyst bed. Such an exemplary process can be an effective means to provide Br₂, with Br₂ yields ranging from about 30% to about 90% and greater depending on the process conditions. With reference to FIG. 1, for example, Br₂ can be formed from CaBr₂ in various yields, depending on the process temperature, including yields of at least 35% at about 1150° F. (621° C.), at least 65% at about 1250° F. (676° C.), at least 65% at about 1275° F. (690.5° C.), and at least 85% at about 1350° F. (732° C.). The process temperatures above generally refer to the temperature of the reactor used in the HBr generating process. As will be apparent, Br₂ can be provided in various yields depending on the reaction conditions, and thus the amount of Br₂ being formed and injected into the process stream can be modulated as needed.

In one specific aspect, a method for producing bromine comprises forming hydrobromic acid from a bromide salt and contacting the hydrobromic acid with oxygen and a metal oxide catalyst under conditions sufficient to oxidize at least a portion of the hydrobromic acid to bromine. Forming the hydrobromic acid can comprise contacting the bromide salt with an effective amount of steam, thereby forming hydrobromic acid. The bromide salt can comprise one or more of NaBr, KBr, MgBr₂, or CaBr₂. The metal of the metal-oxide catalyst can comprise copper, cerium, nickel, or manganese.

In one aspect, the molecular halogen can be produced in a system comprising a first reaction chamber and a second reaction chamber comprising a catalyst bed, wherein the second reaction chamber is in fluid communication with the first reaction chamber, and wherein the second reaction chamber is in constant or selective fluid communication with a duct through which flue gas can flow. The system can also comprise a heater for heating at least the first reaction chamber, the second reaction chamber, or both. Typically, the heater can heat the first reaction chamber to induce the formation of the acid halide. The second reaction chamber comprising the catalyst bed can be heated with a heater and/or can be insulated with a layer of insulation, so that heat is not lost into the atmosphere; the process gas from the first reactor can be maintained at sufficient temperature to drive the reaction across the catalyst in the second reactor, without the need for adding any additional heat.

The acid halide can be formed in the first reaction chamber and subsequently pass to the second reaction chamber comprising the catalyst bed. Once the catalyst bed catalyzes the formation of the molecular halogen from the acid halide, the molecular halogen can exit the system and flow into a duct of an industrial process, such as a flue gas duct. The industrial process, as discussed above, can be a coal-combustion process, and thus the duct can be a duct in a coal-combustion plant.

The system can also further comprise a mechanism for delivering the halide salt to the first reaction chamber, such as an inlet line, eductor, moving belt, or other mechanism. The system can also further comprise a means for collecting and removing byproducts from a reaction carried out in the first reaction chamber, such as a settling chamber at the bottom of the system, or other byproduct collection system. The system can also comprise a filter which can prevent particle carryover from the first reaction chamber to the second reaction chamber. The system can also comprise a mechanism for introducing air, steam, or a combination thereof into the first reaction chamber.

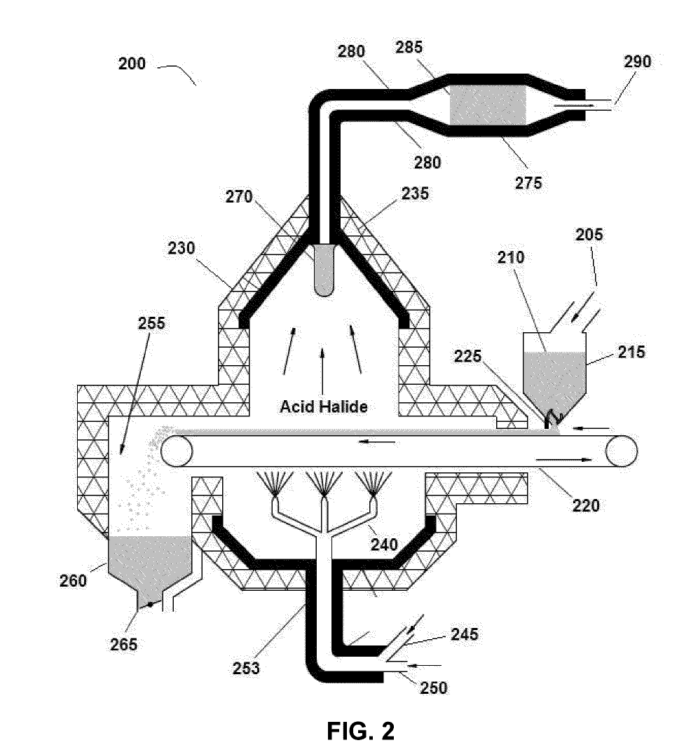

An exemplary system for forming the molecular halogen is depicted in FIG. 2. In this system 200, the halide salt 210 is first introduced at a point 205 into a halide salt hopper 215. The hopper 215 dispenses the halide salt 210 onto a moving grate 220. The halide salt 210 can be evenly dispersed on the moving grate 220 using a moving brush 225 that is connected to the hopper 215. The moving grate 220 conveys the halide salt into a reaction chamber 230 wherein the halide salt 210 will be converted into the acid halide. The reaction chamber 230 can be insulated with insulation 235 to avoid losing heat from the chamber 230 to the atmosphere. Once inside the reaction chamber 230, the halide salt 210 is exposed to air and steam which is introduced into the chamber 230 using steam and air inlet lines 240. In this example, the air is introduced into the inlet lines 240 from the atmosphere through an air line 245, while steam is introduced into a steam inlet line 250 from a steam source. In one specific example, steam can be produced from the industrial process itself at a temperature of about 800° F. (426.6° C.) and subsequently injected into the inlet lines 240 of the system.

During the process of forming the acid halide, the reaction chamber 230 is heated to from about 650° C. to about 1000° C. using a heater 253, such as an electric heater, that is present inside or near the reaction chamber 230. In carrying out the reaction process, once the halide salt 210 is converted into the acid halide, the solid reaction byproducts 255, such as alkalyn oxides or hydroxides, are conveyed from the moving grate 220 into a byproduct hopper 260 which can be equipped with a timer hopper-level actuated damper 265 for releasing the solid byproducts 255 from the byproduct hopper 260. In some cases, the reaction byproducts can be useful elsewhere in the industrial process. The acid-halide vapor that is produced from the halide salt 210 passes through a high temperature thimble filter 270 which prevents any particle carryover to the catalyst chamber.

The acid halide vapor is then directed to a catalyst chamber 275 which can be heated with an electric heater 280. The catalyst chamber 275 comprises a catalyst bed 285 that comprises a catalyst (e.g., CuO) for oxidizing the acid halide to the molecular halogen. Upon passing through the catalyst bed 285, the acid halide will be converted to the molecular halogen, which passes through the remainder of the catalyst chamber 275 and exits the system at an exit point 290.

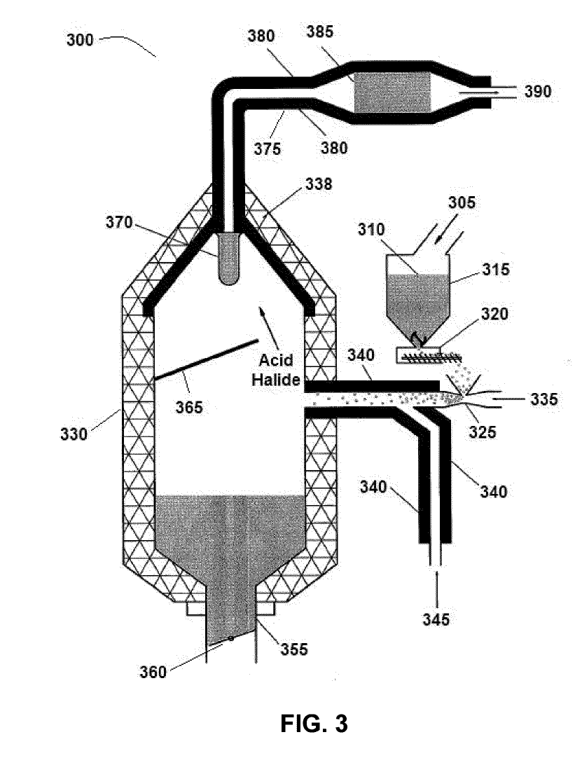

Another exemplary system for forming the molecular halogen is depicted in FIG. 3. In this system 300, the halide salt 310 is first introduced at a an entry point 305 into a halide salt hopper 315. The hopper 315 dispenses the halide salt 310 into a gravimetric feeder 320, which feeds the halide salt 310 into an eductor 325, wherein the halide salt is suspended and pushed into a heated reaction line 340 using a stream of air 335. The stream of air 335 also flows into the heated reaction line 340 and is used in the reaction process. The reaction products (acid halide and byproducts) flow immediately from the heated reaction line to a settling chamber 330 that is insulated with insulation 338 to avoid losing too much heat from the chamber 330 to the atmosphere. While flowing through the reaction line 340, the halide salt and gases are heated by an external or in-line heater 340, such as an electric heater. Steam is also introduced into the reaction line 340 through a steam inlet line 345. The halide salt 310 will react with the steam inside the heated reaction line 340, before reaching the settling chamber 330 and somewhat after reaching the settling chamber 330. The reaction byproducts 355 collect in the bottom of the settling chamber 330, and can exit the settling chamber through the action of a timer- or loading-actuated damper 360. The settling chamber 330 contains a knockout plate 365 to help divert the flow of solids to the bottom of the settling chamber 330.

The acid halide vapor that is produced from the halide salt 310 passes through a high temperature thimble filter 370, which prevents particle carryover to the catalyst. The acid halide vapor is then directed to a catalyst chamber 375 which can be optionally heated with an electric heater 380, if necessary or desired, and/or can be insulated with insulation, thus using the heat already in the system (used to drive the formation of HBr) to further drive the catalytic reaction to form Br₂. The catalyst chamber 375 comprises a catalyst bed 385 that comprises a catalyst (e.g., CuO) for oxidizing the acid halide to the molecular halogen. Upon passing through the catalyst bed 385, the acid halide will be converted to the molecular halogen, which then passes through the remainder of the catalyst chamber 375 and exits the system at point 390.

Once through the catalyst bed of a system (285, 385), the molecular halogen can be injected directly into (and mixed with) a flue gas. Generally, as discussed above, the present invention can be used in combination with industrial process wherein flue gas is produced that contains mercury, including a variety of combustion and production processes. Exemplary combustion processes include fossil-fuel-fired combustion processes (e.g., coal combustion processes), waste combustion processes (e.g., municipal solid waste, MSW, or hazardous-waste combustion), biomass combustion processes, and others. Other industrial processes include without limitation metal smelting processes, such as gold smeting, and production processes, such as chemical production processes, for example, chlor alkali production processes. Typically, the molecular halogen is injected into the flue gas (exhaust) of a process stream of the industrial process. Depending on the nature of the industrial process, the flue gas may pass through a variety of process points, any one of which can be a suitable injection point for the molecular halogen. In one aspect, the molecular halogen is injected into the gaseous effluent (i.e., the flue gas that is no longer used in the process, other than for heat recovery and will be discarded) of an industrial process stream.

In one specific aspect wherein the molecular halogen is injected into a combustion-based power-plant process, it can be desirable to inject the molecular halogen at, upstream, or within layers of a selective catalytic reduction (SCR) unit or a point just after the selective catalytic reduction unit. Other suitable injection points include at or upstream of an air heater, an electrostatic precipitator (ESP), a wet or dry scrubber, or another existing pollution-control device used in connection with the power-plant process.

In some aspects, the system is in-line or in fluid communication with the flue gas of an industrial process or a duct through which the flue gas flows, such that the molecular halogen formed can be directly injected into a point in the process stream, e.g., a point in the flue gas stream. The amount of molecular halogen to be injected will typically vary depending on the composition of the gas stream and other variables (e.g., residence time and control strategy), but will typically be at least 2 parts per million by volume of flue gas (ppmv) and up to about 300 ppmv or greater depending on the process, plant configuration, location of injection, flue gas composition, and the desired result of the injection. In a coal fired power plant, for example, the molecular halogen can be injected in a concentration of from about 2 ppmv to about 300 ppmv. The amount injected can be modulated as discussed above through the system process or through the selective fluid communication of the molecular halogen with the process stream.

Once the molecular halogen comes in contact with a flue gas comprising mercury, the molecular halogen can convert the mercury to an oxidized form, which is more easily captured by existing pollution control devices and which thereby decreases the emission of mercury from the flue gas into the atmosphere. Without wishing to be bound by theory, when the molecular halogen is bromine, it is believed that Br, reacts with mercury to produce HgBr₂, which is easily captured by typical pollution control devices, such as wet scrubbers. It should be appreciated that once HgBr₂ is captured by a wet scrubber, it is more likely to be retained in the scrubber liquid than HgCl₂, which is known to at least partially reemit into the flue gas. For additional details regarding the oxidation of mercury by Br₂, see, for example, Liu et al., Environ. Sci. Technol. 2007, 41, 1405-1412, which is incorporated herein by this reference, for its teaching of mercury oxidation by Br₂. In some aspects, the mercury can be in vapor form before it is oxidized by the molecular halogen and subsequently removed from the flue gas.

The present invention provides for a safe method for injecting a molecular halogen directly at the location of need to reduce mercury emission from a flue gas. Relatively inert halide salts can be transported to the site of an industrial process and stored until they are used to form the molecular halogen. The molecular halogen is formed on site, in a single system, such that it will be directly injected into a point in the process stream, such as a point in the flue-gas stream as soon as it is formed, thus avoiding the unsafe handling and transport of molecular halogens, acid halides, or other acids or liquids that typically have a high vapor pressure and are toxic. Thus, storage of the molecular halogen, acid halide, or other acids or liquids is not necessary. In addition to providing a safe method for mercury oxidation, the present invention also enables the practical use of a molecular halogen, which is an excellent mercury oxidant, by forming the molecular halogen on site of the industrial process, actually in the injection system itself.

Additionally, during the practice of the present invention, the molecular halogen is formed outside of the industrial process stream and then is injected into the process, as opposed to forming the molecular halogen as part of the process itself, for example by placing a halide salt on fuel, such as coal, and allowing a molecular halogen to form during the combustion process. By forming the molecular halogen separately from the process, the formation of the molecular halogen is ensured and the molecular halogen is shielded from consumption by other reactants in the process, and/or shielded from capture by other commonly used pollution control devices. Additionally, by forming the molecular halogen separately from the combustion process, process components upstream of point of use or need for the molecular halogen are shielded from corrosive molecular halogen vapors.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in C or is at ambient temperature, and pressure is at or near atmospheric.

### Example 1

### Formation of Br₂ from CaBr₂ in Simulated System Environment

To prepare the copper oxide catalyst, 150 g of copper (II) nitrate trihydrate was dissolved in 200 ml of deionized water and then poured over 200 grams of 8-14 mesh activated alumina. The resulting catalyst composite was dried and then calcined at 1112° F. for 2 hours.

Powdered calcium bromide (CaBr₂) was placed in a sand bed, and the sand bed was heated to between 1100° F. and 1350° F. The sand was used to disperse the calcium bromide, thereby better simulating the contact between the powder, steam, and air that will exist in a full-sized working system, wherein the calcium bromide will react with the steam and oxygen as a dispersed and suspended powder. When the desired temperature range was reached, a stream of 20% steam and 80% air was directed through the sand bed of calcium bromide (CaBr₂). The exhaust from this reaction was then allowed to cool to 800° F. before it was directed through the copper-oxide catalyst bed.

The exhaust was then directed through the copper-oxide catalyst bed. Bromine gas (Br₂) formed via the catalytic reaction and H₂O formed during the reaction were condensed at the outlet of the copper-oxide catalyst bed. The concentration of the Br₂ was determined by ion chromatography. As shown in FIG. 1, the percent of CaBr₂ that was converted to Br₂ increased with increasing reaction temperature for the first step of the process, wherein CaBr₂ was converted into HBr. The temperature of the catalyst for the second step was continuously maintained just below about 800° F., at about 750° F. Using a first-step reactor temperature of 1350° F., about 85% of the CaBr₂ was converted to Br₂. The true conversion may have been even higher than measured, potentially due to a loss of bromine gas on the system walls. In the commercial-version of the process, this would likely be eliminated by using a larger system with a higher flowrate and if necessary, inert coatings on the inner surfaces of the injection system.

### Example 2

### CaBr₂/H₂O Slurry

A mixture of CaBr₂ and water was injected through the steam generator and then into the system. The CaO from the solution dried and collected at the copper catalyst bed but no measurable Br₂ was formed. Without wishing to be bound by theory, it is believed that when the CaBr₂ is put into aqeuous solution, a mixture of Ca(OH)₂ and Br⁻ are formed, and HBr does not form as needed.

Various modifications and variations can be made to the methods, compounds, systems, and compositions described herein. Other aspects of the methods, compounds, systems, and compositions described herein will be apparent from consideration of the specification and practice of the methods, compounds, systems, and compositions disclosed herein. It is intended that the specification and examples be considered as exemplary.

What is claimed is:

1. A method for decreasing the amount of mercury in a flue gas, comprising:
a) forming a molecular halogen from a halide salt;
b) injecting the molecular halogen into a mercury containing flue gas in an amount effective to oxidize at least a portion of the mercury in the flue gas; and
c) removing at least a portion of the oxidized mercury from the flue gas, thereby decreasing the amount of mercury in the flue gas.

2. The method of claim 1, wherein the molecular halogen is formed at or near the site of an industrial process.

3. The method of claim 2, wherein the industrial process comprises coal combustion.

4. The method of claim 1, wherein the molecular halogen is formed in an injection system that is in fluid communication or selective fluid communication with the flue gas of an industrial process.

5. The method of claim 1, wherein forming the molecular halogen from the halide salt comprises:
(a) forming an acid halide from the halide salt; and
(b) oxidizing the acid halide to form the molecular halogen.

6. The method of claim 1, wherein the molecular halogen is formed from the halide salt in a percent yield of at least 30%.

7. The method of claim 1, wherein the molecular halogen is formed from the halide salt in a percent yield of at least 80%.

8. The method of claim 1, wherein the molecular halogen is injected into a combustion process stream at any point from a burner to a flue gas stack.

9. The method of claim 1, wherein the molecular halogen is injected into a combustion process stream near or within a selective catalytic reduction (SCR) unit, at or upstream of an air heater, within or upstream of an electrostatic precipitator (ESP), or at or upstream of a wet or dry scrubber.

10. The method of claim 1, wherein the molecular halogen is Br₂.

11. The method of claim 1, wherein the halide salt comprises one or more of NaBr, KBr, MgBr₂, or CaBr₂.

12. The method of claim 1, wherein an ESP, wet ESP, or a wet scrubber is used to remove at least a portion of the oxidized mercury from the flue gas.

13. A system for producing a molecular halogen, comprising:
a) a first reaction chamber; and a second reaction chamber comprising a catalyst bed, wherein the second reaction chamber is in fluid communication with the first reaction chamber, wherein the second reaction chamber is in constant or selective fluid communication with a duct through which flue gas can flow; and
b) a heater for heating at least one of the first reaction chamber or the second reaction chamber.

14. The system of claim 13, wherein the second reaction chamber is in constant or selective fluid communication with a flue-gas duct of an industrial process plant.

15. The system of claim 14, wherein the industrial process plant is a coal combustion plant.

16. The system of claim 13, further comprising a means for delivering a halide salt to the first reaction chamber.

17. The system of claim 13, further comprising a means for collecting and removing byproducts from a reaction carried out in the first reaction chamber.

18. The system of claim 13, further comprising a filter which can prevent particle carryover from the first reaction chamber to the second reaction chamber.

19. The system of claim 13, further comprising a means for introducing air, steam, or a combination thereof into the first reaction chamber.

20. A method for making bromine, comprising:
a) forming hydrobromic acid from a bromide salt; and
b) contacting the hydrobromic acid with oxygen and a metal oxide catalyst under conditions sufficient to convert at least a portion of the hydrobromic acid to bromine and water.

21. The method of claim 20, wherein forming the hydrobromic acid comprises contacting the bromide salt with an effective amount of steam, thereby forming hydrobromic acid.

22. The method of claim 20, wherein the bromide salt comprises one or more of NaBr, KBr, MgBr₂, or CaBr₂.

23. The method of claim 20, wherein the metal of the metal oxide catalyst comprises copper, cerium, nickel, or manganese.
